(19) United States
(12) Patent Application Publication
(10) Pub. No.: US 2017/0339265 A1
(43) Pub. Date: Nov. 23, 2017

(54) USER EQUIPMENT SERVICE MANAGEMENT

(71) Applicant: QUALCOMM Incorporated, San Diego, CA (US)

(72) Inventors: Ajeet KUMAR, Hyderabad (IN); Ajay K.R. BODDU, Hyderabad (IN); Arun KHANNA, Hyderabad (IN); Sabyasachi BHATTACHARYA, Bengaluru (IN)

(21) Appl. No.: 15/160,521

(22) Filed: May 20, 2016

(51) Int. Cl. H04M 1/725; H04W 4/00; H04W 84/12

(52) U.S. Cl. CPC H04M 1/72522; H04W 4/008; H04M 2250/10; H04W 84/12

(57) ABSTRACT

The present application relates to service management at a user equipment (UE). The described aspects include determining whether at least one activated service satisfies a termination condition based on detecting that a service deactivation triggering condition has been met. The described aspects further include determining whether the at least one activated service was activated based on an indication received from an interface unit of the UE based on determining that the at least one activated services satisfies the termination condition. Additionally, the described aspects include terminating operation of the at least one activated service based on determining that the at least one activated service satisfies the termination condition and the at least one service was not activated by the interface unit between the application and the at least one activated service.

### BACKGROUND

The present disclosure relates generally to communication systems, and more particularly, to managing one or more services at a user equipment (UE).

Wireless communication systems are widely deployed to provide various telecommunication services such as telephony, video, data, messaging, and broadcasts. Use of communication devices within such systems has dramatically increased. Communication devices often provide access to a network, such as a Local Area Network (LAN) or the Internet, for example. Other communication devices (e.g., access terminals, laptop computers, smart phones, media players, gaming devices, etc.) may wirelessly communicate with communication devices that provide network access. Some communication devices comply with certain industry standards, such as the Institute of Electrical and Electronics Engineers (IEEE) 802.11 (e.g., Wireless Fidelity or “Wi-Fi”) standards. Communication device users, for example, often connect to wireless networks using such communication devices.

As the use of communication devices has increased, advancements in communication device capacity, reliability and efficiency are being sought. In particular, communication devices typically operate according to limited resources such as, but not limited to, a data allotment and/or power supply. As such, efficient use of the limited UE resources may be beneficial in extending the use of communication devices, for example, by decreasing battery power consumption or network data plan consumption. Accordingly, systems and methods that improve communication device capacity, reliability, communication range, and/or efficiency may be beneficial.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method relates to service management at a user equipment (UE). The described aspects include detecting that a service deactivation triggering condition has been met. The described aspects further include determining whether at least one activated service satisfies a termination condition in response to detecting that the service deactivation triggering condition has been met. The described aspects further include maintaining operation of the at least one activated service based on determining that the at least one activated service does not satisfy the termination condition. The described aspects further include determining whether the at least one activated service was activated in response to an indication received from an interface unit of the UE based on determining that the at least one activated services satisfies the termination condition. The described aspects further include terminating operation of the at least one activated service based on determining that the at least one activated service satisfies the termination condition and the at least one activated service was not activated by the interface unit between the application and the at least one activated service. The described aspects further include maintaining operation of the at least one activated service based on determining that the at least one activated service satisfies the termination condition and the at least one activated service was activated by the interface unit of the UE.

In accordance with an aspect, an apparatus relates to service management. The described aspects include means for detecting that a service deactivation triggering condition has been met. The described aspects further include means for determining whether at least one activated service satisfies a termination condition in response to detecting that the service deactivation triggering condition has been met. The described aspects further include means for maintaining operation of the at least one activated service based on determining that the at least one activated service does not satisfy the termination condition. The described aspects further include means for determining whether the at least one activated service was activated in response to an indication received from an interface unit of the UE based on determining that the at least one activated services satisfies the termination condition. The described aspects further include means for terminating operation of the at least one activated service based on determining that the at least one activated service satisfies the termination condition and the at least one activated service was not activated by the interface unit between the application and the at least one activated service. The described aspects further include means for maintaining operation of the at least one activated service based on determining that the at least one activated service satisfies the termination condition and the at least one activated service was activated by the interface unit of the UE.

In accordance with an aspect, a computer-readable medium storing computer executable code relates to service management. The described aspects include code to detect that a service deactivation triggering condition has been met. The described aspects further include code to determine whether at least one activated service satisfies a termination condition in response to detecting that the service deactivation triggering condition has been met. The described aspects further include code to maintain operation of the at least one activated service based on determining that the at least one activated service does not satisfy the termination condition. The described aspects further include code to determine whether the at least one activated service was activated in response to an indication received from an interface unit of the UE based on determining that the at least one activated services satisfies the termination condition. The described aspects further include code to terminate operation of the at least one activated service based on determining that the at least one activated service satisfies the termination condition and the at least one activated service was not activated by the interface unit between the application and the at least one activated service. The described aspects further include code to maintain operation of the at least one activated service based on determining that the at least one activated service satisfies the termination condition and the at least one activated service was activated by the interface unit of the UE.

In accordance with an aspect, an apparatus comprising a memory and at least one processor coupled to the memory relates to service management. The at least one processor is configured to detect that a service deactivation triggering condition has been met. The at least one processor is further configured to determine whether at least one activated service satisfies a termination condition in response to detecting that the service deactivation triggering condition has been met. The at least one processor is further configured to maintain operation of the at least one activated service based on determining that the at least one activated service does not satisfy the termination condition. The at least one processor is further configured to determine whether the at least one activated service was activated in response to an indication received from an interface unit of the UE based on determining that the at least one activated services satisfies the termination condition. The at least one processor is further configured to terminate operation of the at least one activated service based on determining that the at least one activated service satisfies the termination condition and the at least one activated service was not activated by the interface unit between the application and the at least one activated service. The at least one processor is further configured to maintain operation of the at least one activated service based on determining that the at least one activated service satisfies the termination condition and the at least one activated service was activated by the interface unit of the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is an example UE that may be used in an operating environment that can control and/or manage services in accordance with an aspect of the present disclosure.

FIG. 2 is a conceptual diagram of the service manager in accordance with an aspect of the present disclosure.

FIGS. 3 and 4 are flow charts illustrating an example method of service management in accordance with various aspect of the present disclosure.

FIG. 5 is a diagram illustrating an example of a hardware implementation for an apparatus employing a processing system including a service manager in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, various structures and components are shown in block diagram form in order to avoid obscuring such concepts.

Several aspects of communication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station,” a “smartphone,” a “tablet” and variations thereof.

The terminology used herein is for the purpose of describing particular embodiments only and is not intended to be limiting of embodiments of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Some UEs use various services to facilitate wireless communication with a network (e.g., via a base station or network entity). Many of these services may be associated with or otherwise rely upon a hardware component/module within the UE. For example, a global positioning system (GPS) component/module, when enabled, may provide location information of the UE to a certain degree of accuracy (e.g., within a certain number of feet). Further, for instance, a Bluetooth component/module, when enabled, may enable a first UE to engage in short range communication (e.g., exchange of data) with a second UE. A UE may also communicate according to a wide area local network (WLAN) and/or a wide area wireless network (WWAN). However, some of these services, when left active, consume limited resources such as the UE's power supply (e.g., battery) and allotted data limit (e.g., UE may be on a data plan with a limited amount of data per defined period).

The present disclosure relates to power and resource management in a UE. Specifically, the present aspects provide for a UE that, via a service manager (also referred to herein as a central services moderator), may manage service (e.g., GPS, WLAN, Bluetooth, WWAN) activation and deactivation. For example, upon execution of, and request by an application running on the UE, one or more services used by the application may be activated by the service manager. The service manager may further log the activation of a service by recording or maintaining a list of applications requesting and/or using a respective service. When the application ceases to operate (e.g., the application may be closed/terminated), rather than allowing the one or more services that were enabled or activated to remain enabled or activated, the service manager may autonomously deactivate the one or more services. For instance, the service manager may determine whether there are any services for which there is no active application (client), and if so, may terminate or deactivate the service if the service was activated by the central services moderator. As such, the service manager may manages activation and deactivation of the services to reduce consumption of limited battery power and/or data resources.

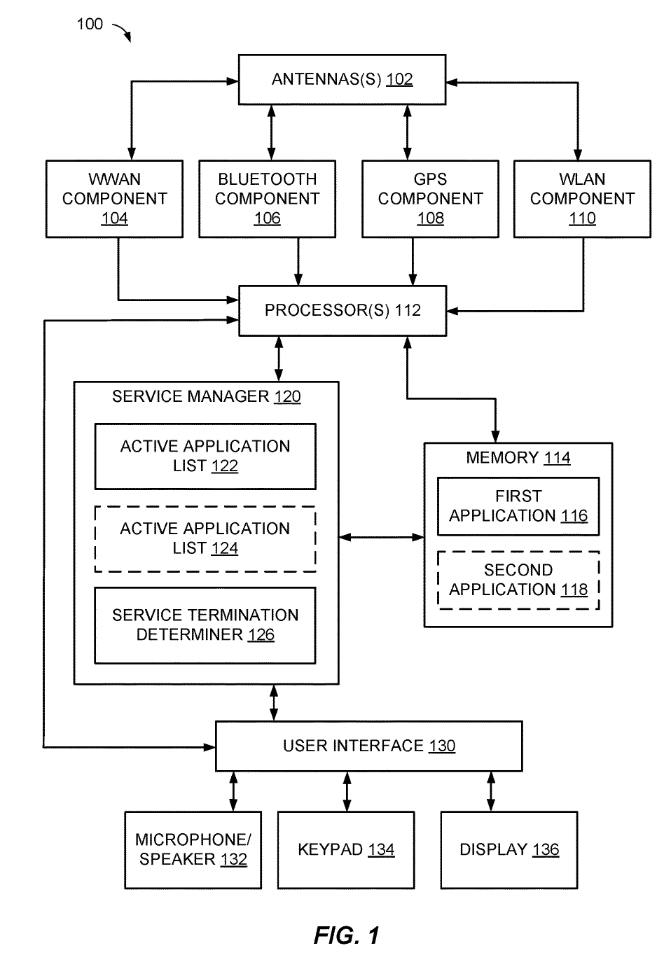

FIG. 1 is a block diagram illustrating various components of an example UE 100. For the sake of simplicity, the various features and functions illustrated in the box diagram of FIG. 1 are connected together using a common bus which is meant to represent that these various features and functions are operatively coupled together. Those skilled in the art will recognize that other connections, mechanisms, features, functions, or the like, may be provided and adapted as necessary to operatively couple and configure an actual portable wireless device. Further, it is also recognized that one or more of the features or functions illustrated in the example of FIG. 1 may be further subdivided or two or more of the features or functions illustrated in FIG. 1 may be combined.

The UE 100 may include a WWAN component 104 that may be connected to one or more antennas 102. The WWAN component 104 may include suitable devices, hardware, and/or software for communicating with and/or detecting signals to/from a network entity such as an access point and/or base station, and/or directly with other wireless devices (e.g., other UEs) within a communication network. In an aspect, the WAN component 104 may comprise a CDMA communication system suitable for communicating with a CDMA network of wireless base stations; however in other aspects, the wireless communication system may comprise another type of cellular telephony network, such as, for example, TDMA or GSM. Additionally, any other type of wide area wireless networking technologies may be used, for example, WiMAX (802.16), TDNM, OFDM, GPRS, EV-DO, S02.xx, UWB, and/or LTE.

The UE 100 may also include a WLAN component 110 that may be connected to one or more antennas 102. The WLAN component 110 may include suitable devices, hardware, and/or software for communicating with and/or detecting signals to/from a network entity such as an access point, and/or directly with other wireless devices (e.g., UEs) within a communication network. In an aspect, the WLAN component 110 may include a Wi-Fi (e.g., IEEE 802.11a/b/g/n, IEEE 802.16, and/or IEEE 802.20) communication system suitable for communicating with one or more wireless access points; however in other aspects, the WLAN component 110 may include another type of local area network, e.g., a personal area network.

In some aspects, the UE 100 may include a GPS component 108 that may be connected to one or more antennas 102. The GPS component 108 may include suitable devices, hardware, and/or software for receiving and processing satellite signals. Further, the UE 100 may include a Bluetooth component 106 that may be connected to one or more antennas 102 for receiving signals according to IEEE 802.15. The Bluetooth component 106 may include suitable devices, hardware, and/or software for receiving and processing Bluetooth signals. Additionally, any other type of wireless networking technologies may be used, for example, ZigBee.

The UE 100 may also include processor 112. The processor 112 may be connected to the WWAN component 104, Bluetooth component 106, GPS component 108, and WLAN component 110. The processor 112 may include one or more microprocessors, microcontrollers, and/or digital signal processors that provide processing functions, as well as other calculation and control functionality. The processor 112 may communicate, or in some non-limiting aspects include memory 114 for storing data and software instructions for executing programmed functionality within the UE 100. In some aspects, the memory 114 may be on-board the processor 112 (e.g., within the same IC package), and/or the memory 114 may be external memory that is functionally coupled to the processor 112 over a data bus.

In some aspects, memory 114 may include any type of computer-readable medium usable by a computer or processor 112, such as random access memory (RAM), read only memory (ROM), tapes, magnetic discs, optical discs, volatile memory, non-volatile memory, and any combination thereof. In an aspect, for example, memory 114 may be a computer-readable storage medium (e.g., a non-transitory medium) that stores computer-executable code. The computer-executable code may define one or more operations or functions of service manager 120 and/or one or more of its subcomponents, and/or data associated therewith. Further, each of WWAN component 104, Bluetooth component 106, GPS component 108, and/or WLAN component 110 may comprise hardware, firmware, and/or software and may be configured to execute code or perform instructions stored in a memory (e.g., a computer-readable storage medium).

A number of software modules and/or applications may reside in memory 114 and be utilized by the processor 112 and/or other components of the UE 100 in order to manage communications and/or services. As illustrated in FIG. 1, memory 214 may include a first application 116 and a second application 118. One should appreciate that the organization of the memory contents as shown in FIG. 1 is merely an example, and as such the functionality of the modules and/or data structure may be combined, separated, and/or be structured in different ways depending upon the implementation of the UE 100. For example, memory 114 may include or otherwise store one or more applications including the first application 116 and the second application 118. While the one or more applications shown in FIG. 1 are illustrated in the example as being contained in the memory 114, in certain implementations such procedures may be provided for or otherwise operatively arranged using other or additional mechanisms.

Further, the processor 112 may include any form of logic suitable for performing at least the techniques provided herein. For example, the processor 112 may be operatively configurable based on instructions in the memory 114 to selectively initiate one or more routines and/or applications.

The UE 100 may include a user interface 130 which may be configured to provide any suitable interface systems, such as a microphone/speaker 132, keypad 134, and/or display 136 that allows user interaction with the UE 100. The microphone/speaker 132 may be configured to provide for voice communication services using one or more of the WWAN component 104, Bluetooth component 106, and/or WLAN component 110. The keypad 134 may include any suitable buttons for user input, which may also include other external hardware inputs of the UE 100. The display 136 may include any suitable display, such as, for example, a backlit LCD display, and may further include a touch screen display for additional user input modes.

The UE 100 may also include service manager 120, which may conserve limited resources (e.g., data allocation and/or power supply such as a battery) of the UE 100 by autonomously monitoring the use of active services such as a WWAN service associated with WWAN component 104, a WLAN service associated with WLAN component 110, a Bluetooth service associated with Bluetooth component 106, and/or a GPS service associated with GPS component 108. For example, the UE 100 may, via processor 112, execute one or more applications (e.g., first application 116) residing in memory 114. As part of running or executing the one or more applications (e.g., first application 116), one or more services (e.g., WLAN service) each associated with a corresponding component (e.g., WLAN component 110) may be activated.

In some aspects, upon termination of an application (e.g., first application 116), the one or more services such as the WLAN service, may often remain active and continue to consume limited resources, such as an allocated amount of data and/or power supply (e.g., battery). As such, service manager 120 may be configured to autonomously monitor and adjust and/or terminate operation of an active service when such service is no longer used by any application. That is, service manager 120 may be configured to control and/or manage at least the WWAN service, WLAN service, Bluetooth service, and/or GPS service. In some aspects, service manager 120 may be communicatively coupled to processor 112, memory 114, and/or user interface 130. Further, in some aspects, service manager 120 may be the same as or alternatively referred to as a service management entity.

In an aspect, during service activation, service manager 120 may be configured to receive a request from an application (e.g., first application 116 and/or second application 118) to activate at least one service associated with a hardware component of the UE 100. For example, the processor 112, via user interface 130, may detect an input representing a selection or activation of a first application 116 (e.g., using microphone/speaker 132, keypad 134 and/or display 136). In such example, first application 116 may, as part of operating, use data from at least one of a WWAN service, a WLAN service, a Bluetooth service, and/or a GPS service. Accordingly, service manager 120 may receive a request from first application 116 to activate at least one of the WWAN service, the WLAN service, the Bluetooth service, and/or the GPS service.

Further, service manager 120 may be configured to determine whether the service requested by an application is currently active. For instance, in the example where a request is received from the first application 116 to activate a WLAN service associated with WLAN component 110, service manager 120 may initially determine whether the WLAN service associated with the WLAN component 110 is active, e.g., being used by another application running on the UE 100.

In an aspect where service manager 120 determines that the requested service is active, service manager 120 may be configured to add the application requesting the service to a corresponding active application list associated with the requested service, e.g., active application list 122 and/or 124 . That is, in some aspects, active application list 122 may be associated with a single service. In such aspect, in the example of an activation request for the WLAN service, active application list 122 may be associated with the WLAN service. As such, each active application requesting the WLAN service may be added to active application 122. In an aspect where service manager determines that the requested service or services are inactive, service manager 120 may be configured to initially activate the requested service and add the application requesting the service or services to the corresponding active application list 122 and/or 124 associated with the requested service.

To reduce inefficient utilization of limited resources of the UE 100 during use or activation of one or more services (e.g., WWAN service, WLAN service, Bluetooth service, and/or GPS service), service manager 120 may actively monitor for triggering conditions or events to determine whether to adjust and/or terminate one or more activated services. Specifically, service manager 120 may initially detect that a service deactivation triggering condition has been met. For example, the service deactivation triggering condition may be a detection by service manager 120 of a termination of an active application. That is, in an example, one of first application 116 or second application 118 may have been previously opened or activated using user interface 130. Upon termination or closure of the activated or open application, service manager 120 may receive a termination indication from one or more of the active applications to be terminated, processor 112, and/or memory 114. Further, in some aspects, service manager 120 may periodically poll for one or more active applications. That is, service manager 120 may periodically receive information including the one or more active applications from one or more of the active application to be terminated, processor 112, and/or memory 114. As such, in such an example where one of first application 116 or second application 118 was activated, service manager 120 may detect a deactivation or termination of that application.

Further, based on detecting that the service deactivation triggering condition has been met, and more specifically, a detection or identification of a termination or closure of an active application, service manager 120 may, via service termination determiner 126, determine whether one or more activated services satisfy a termination condition. In other words, service termination determiner 126 of service manager 120 may, upon receiving an indication of a termination or closure of a previously active application, be configured to determine whether one or more services used during operation or execution of the previous active application (but now terminated), may also be deactivated.

In particular, to determine whether the one or more activated services satisfy the termination condition, service termination determiner 126 may be configured to determine whether the one or more activated services remain active when the corresponding active application list (e.g., active application list 122 and/or 124) does not include at least one application (e.g., determine that the list is null) other or in addition to the terminated application triggering the termination condition determination. That is, service manager 120 may, via service termination determiner 126, monitor for any services that were activated and remain active, yet lacks any active applications in a corresponding active application list. For instance, service termination determiner 126 determines whether an active application list lacks an inclusion of at least one application while a corresponding service associated with the active application list remains active. In some aspects, the active application list may include the terminated application during a determination by service termination determiner 126 as to whether the one or more activated services satisfy the termination condition. In some aspects, the active application list may not include the terminated application during a determination by service termination determiner 126 as to whether the one or more activated services satisfy the termination condition.

Further, upon determining that one or more activated services satisfy the termination condition, service termination determiner 126 may be configured to determine whether the one or more activated services were activated based on an indication received from user interface 130 of the UE 100. That is, service termination determiner 126 may determine whether an active service satisfying the termination condition was activated by service manager 120 based on receiving an indication from user interface 130 (e.g., indicative of user activation).

In some aspects, service manager 120 may be configured to maintain operation of the one or more activated services based on a determination that the one or more activated services do not satisfy the termination condition (e.g., an application using the service remains active and/or periodic time duration not met). Further, in aspects where the termination condition has been satisfied, service manager 120 may, in order to reduce inefficient utilization of UE resources (e.g., limited data allocation and/or power supply), be configured to terminate operation of the one or more activated services based on a determination that the one or more activated services were not activated by or via an indication received from the user interface 130. In other words, service manager 120 may terminate operation of or deactivate an active service (e.g., WWAN service, Bluetooth service, GPS service, and/or WLAN service) associated with one or more corresponding component (e.g., WWAN component 104, Bluetooth component 106, GPS component 108, and/or WLAN component 110) when or based on a determination that the termination condition is satisfied (e.g., active application list associated with active service does not include at least one active application) and the active service was not activated by a user (e.g., activated by service manager 120 based on receiving an activation indication from user interface 130).

In some aspects, a termination or deactivation of a service may include a termination or deactivation of a corresponding component. That is, in an aspect where a WLAN service is terminated or deactivated, WLAN component 110 may also be deactivated. Further in an aspect where a WWAN service is terminated or deactivated, WWAN component 104 may also be deactivated. In an aspect where a Bluetooth service is terminated or deactivated, Bluetooth component 106 may also be deactivated. Moreover, in an aspect where a GPS service is terminated or deactivated, GPS component 108 may also be deactivated. Additionally, in some aspects, as part of terminating operation of the service, service manager 120 may be configured to remove or purge one or more applications from the active application client list (e.g., service manager 120 may receive an indication of a termination of an application and clears the application from the corresponding active application list or lists).

In a non-limiting use case, first application 116 may be activated and then subsequently terminates. The first application 116 may utilize or receive data from a Bluetooth service associated with Bluetooth component 106. Further, the Bluetooth service may be associated with or otherwise correspond to active application list 124. As such, upon activation of first application 116, service manager 120 may add first application 116 to active application list 124 associated with the Bluetooth service. In some aspects, active application list 124 may include one or more applications in addition to first application 116. However, in this example, active application list 124 may simply include first application 116. As such, upon a termination or closure of first application 116, service manager 120, and more specifically, service termination determiner 126, may be triggered to remove first application 116 from active application list 124 and to subsequently or concurrently determine whether active application list 122 includes any remaining applications while the Bluetooth service remains active.

In an aspect where active application list 124 includes at least one additional or remaining active application in active application list 124, service manager 120 may forgo deactivating Bluetooth service and hence may maintain operation of Bluetooth service. On the other hand, service termination determiner 126 may determine whether the Bluetooth service was activated in response to receiving an activation indication from user interface 130 when or based on a determination that active application list 124 does not include at least one additional or remaining active application. As such, upon a determination that the Bluetooth service was not activated in response to receiving an activation indication from user interface 130, service manager 120 may terminate or deactivate the Bluetooth service.

As used herein, the UE 100 may be any portable or movable device that is configurable to acquire wireless signals transmitted from, and transmit wireless signals to, one or more wireless communication devices or networks. As shown in FIG. 1, the UE 100 may be representative of such a portable wireless device. Thus, by way of example but not limitation, the UE 100 may include a radio device, a cellular telephone device, a computing device, a personal communication system (PCS) device, or other like movable wireless communication equipped device, appliance, or machine. The term “user equipment” is intended to include all devices, including wireless devices, computers, laptops, etc. which are capable of communication with a server, such as via the Internet, Wi-Fi, or other network. The term “user equipment” is also intended to include devices which communicate with a personal navigation device, such as by short-range wireless, infrared, wire line connection, or other connection. Any operable combination of the above is also considered a “user equipment.” Further, as used herein, the terms “wireless device,” “mobile station,” “mobile device,” “user equipment,” etc. may refer to any type of wireless communication device which may transfer information over a network. The wireless device may be any cellular mobile terminal, personal communication system device, personal navigation device, laptop, personal digital assistant, or any other suitable device capable of receiving and processing network signals.

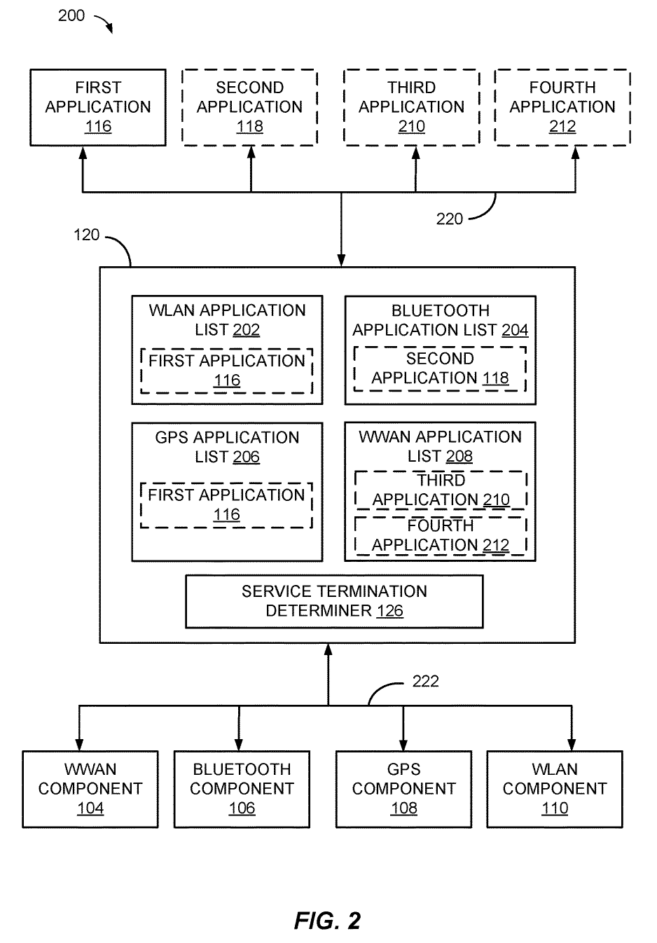

FIG. 2 illustrates a conceptual diagram of service manager 120 within a communication system 200 and in accordance with an aspect of the present disclosure. For example, service manager 120 may communicate with one or more applications and one or more service related components via one or more buses 220 and 222, respectively. Specifically, communication system 200 may include first application 116, second application 118, third application 210, and/or fourth application 212, each of which may be stored or residing in memory 114 (FIG. 1). Further, communication system 200 may include WWAN component 104, Bluetooth component 106, GPS component 108, and/or WLAN component 110.

Service manager 120 may include one or more active application lists each associated with a service of a corresponding component. For example, service manager 120 may include WLAN application list 202, Bluetooth application list 204, GPS application list 206, and/or WWAN application list 208. Service manager 120 may actively monitor the use of various services (e.g., WWAN service, Bluetooth service, GPS service, and/or WLAN service) using any one or more of the aforementioned application lists. For instance, upon an activation or opening of first application 116, which may utilize a WLAN service and/or a GPS service (e.g., request to receive data from WLAN component 110 and/or GPS component 108), service manager 120 may add first application 116 to one or both WLAN application list 202 and GPS application list 206. Additionally, in some aspects, upon detecting a termination or closure of the first application 116, service manager 120 may remove first application 116 from one or both of WLAN application list 202 or GPS application list 206 and determine whether to deactivate one or both of the WLAN service associated with WLAN component 110 or GPS service associated with GPS component 108.

Further, service manager 120 may add second application 118 to Bluetooth application list 204 upon a request for Bluetooth service. Additionally, in some aspects, upon detecting a termination or closure of the second application 118, service manager 120 may remove second application 118 from Bluetooth application list 204 and determine whether to deactivate the Bluetooth service associated with Bluetooth component 106. Moreover, WWAN application list 208 may include third application 210 and fourth application 212, each of which may have requested a WWAN service when activated. In some aspects, upon detecting a termination or closure of the third application 210 and/or fourth application 212, service manager 120 may remove third application 210 and/or fourth application 212 from WWAN application list 208 and determine whether to deactivate the WWAN service associated with WWAN component 104.

The determination of whether to deactivate the service associated with a respective list (e.g., WLAN service/WLAN component 110 associated with WLAN application list 202) may be based on whether the respective list includes any additional applications after a termination and removal of an application previously included in the respective list, and in some cases, an additional determination as to whether the service was activated by service manager 120 in response to receiving an activation indication from a user interface. For instance, in the case of WWAN application list 208, service manager 120 may detect that third application 210 has been terminated. As such, service manager 120 may remove third application 210 from WWAN application list 208. Subsequently or concurrently, service manager 120 may determine whether any additional applications remain in WWAN application list 208. If additional applications remain, then service manager 120 may forgo a subsequent determination as to whether the WWAN service was activated via an activation indication from a user interface.

However, in an aspect whether both third application 210 and fourth application 212 terminate, service manager 120 may remove both third application 210 and fourth application 212 from WWAN application list 208. Service manager 120 may then determine whether any additional applications remain or are included in WWAN application list 208. In such example, no additional applications remain, and as such, service manager 120 subsequently determines whether the WWAN service was activated by an activation indication received from a user interface. If the WWAN service was activated in response to the activation indication received from the user interface, then the WWAN service may remain active even though the WWAN application list 208 does not include any active applications. However, if the WWAN service was not activated in response to the activation indication received from the user interface, service manager 120 may terminate or deactivate WWAN service, which in turn may deactivate the WWAN component 104. Although the foregoing example was described with respect to WWAN application list 208, the aforementioned aspects may also apply to WLAN services associated with WLAN application list 202, Bluetooth services associated with Bluetooth application list 204, and/or GPS services associated with GPS application list 206.

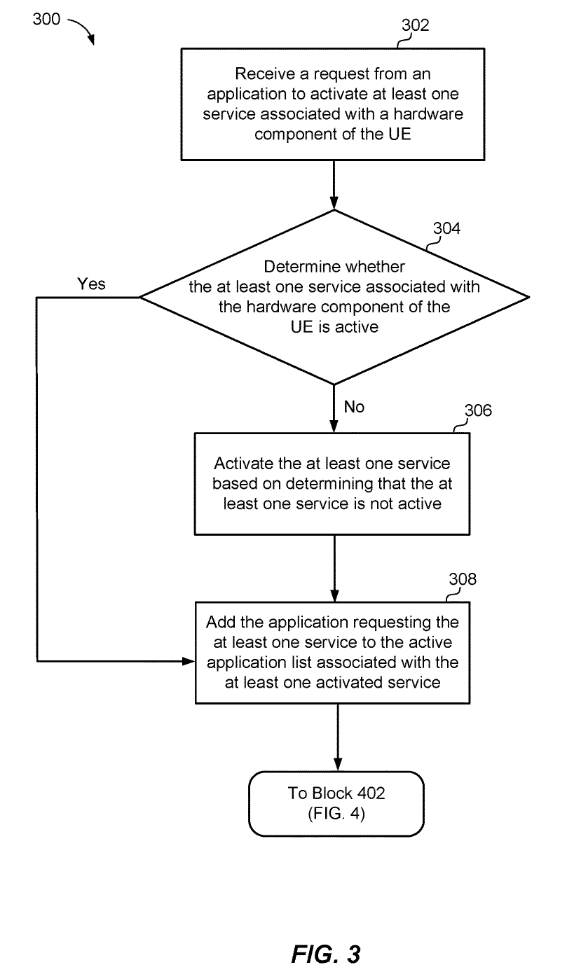

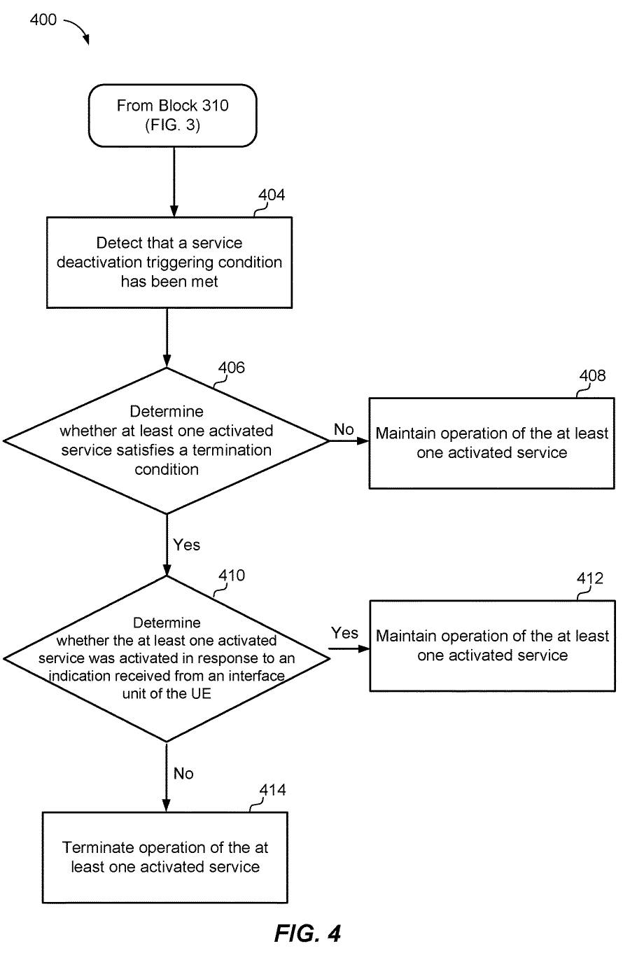

Referring to FIGS. 3 and 4, an example of one or more operations of an aspect of service manager 120 (FIG. 1) according to the present apparatuses and methods are described with reference to one or more methods and one or more components that manage activation and deactivation of one or more services. Although the operations described below are presented in a particular order and/or as being performed by an example component, it should be understood that the ordering of the actions and the components performing the actions may be varied, depending on the implementation. Also, although service manager 120 (FIG. 1) is illustrated as having a number of subcomponents, it should be understood that one or more of the illustrated subcomponents may be separate from, but in communication with, service manager 120 (FIG. 1) and/or each other. Moreover, it should be understood that the following actions or components described with respect to service manager 120 (FIG. 1) and/or its subcomponents may be performed by a specially-programmed processor, a processor executing specially-programmed software or computer-readable media, or by any other combination of a hardware component and/or a software component specially configured for performing the described actions or components.

In an aspect, at 302, method 300 may receive a request from an application to activate at least one service associated with a hardware component of the UE. In an aspect, for example, UE 100 (FIG. 1) may, upon execution of an application (e.g., first application 116 and/or second application 118, FIG. 1) residing memory 114 (FIG. 1) by processor 112 (FIG. 1), receive a request from the application to activate at least one service (e.g., WWAN service, Bluetooth service, GPS service, WLAN service) associated with a hardware component (e.g., WWAN component 104, Bluetooth component 106, GPS component 108, WLAN component 110, FIG. 1) of the UE (e.g., UE 100, FIG. 1).

At block 304, method 300 may determine whether the at least one service associated with the hardware component of the UE is active. In an aspect, for example, UE 100 (FIG. 1) may execute service manager 120 (FIG. 1) to determine whether the at least one service (e.g., WWAN service, Bluetooth service, GPS service, WLAN service) associated with the hardware component (e.g., WWAN component 104, Bluetooth component 106, GPS component 108, WLAN component 110, FIG. 1) of the UE (e.g., UE 100, FIG. 1) is active.

At block 306, method 300 may activate the at least one service based on determining that the at least one service is not active at block 304. In an aspect, for example, UE 100 (FIG. 1) may execute service manager 120 (FIG. 1) to activate the at least one service (e.g., WWAN service, Bluetooth service, GPS service, WLAN service) based on determining that the at least one service is not active or inactive.

Otherwise, at block 308, method 300 may add the application requesting the at least one service to an active application list associated with the at least one service. In some aspects, method 300 may proceed to block 308 directly from block 304 based on determining that the at least one service is active. However, in some aspects, method 300 may proceed to block 308 from block 306 in response to activating the at least one service. In an aspect, for example, UE 100 (FIG. 1) may execute service manager 120 (FIG. 1) to add the application (e.g., first application 116 and/or second application 118, FIG. 1) requesting the at least one service (e.g., WWAN service, Bluetooth service, GPS service, WLAN service) to an active application list (e.g., active application list 122 and/or 124, FIG. 1) associated with the at least one service.

Method 300 may proceed to block 404 of method 400 on FIG. 4.

At block 404, method 400 may detect that a service deactivation triggering condition has been met. In an aspect, for example, UE 100 (FIG. 1) may execute service manager 120 (FIG. 1) to detect that a service deactivation triggering condition has been met. In some aspects, detecting that the service deactivation triggering condition has been met includes determining that a defined time period from a previous polling or check of active applications has been satisfied. In some aspects, detecting that the service deactivation triggering condition has been met includes detecting a termination of the application.

At block 406, method 400 may determine whether at least one activated service satisfies a termination condition. In an aspect, for example, UE 100 (FIG. 1) may execute service manager 120 (FIG. 1) to determine whether at least one activated service (e.g., WWAN service, Bluetooth service, GPS service, WLAN service) satisfies a termination condition in response to detecting that the service deactivation triggering condition has been met. In some aspects, determining whether the at least one activated service satisfies the termination condition includes determining whether the at least one activated service remains active while the active application list (e.g., active applications list 122 and/or 124, FIG. 1) does not include at least one application (e.g., first application 118 and/or second application 116, FIG. 1).

Method 400 may proceed to block 408 based on determining that the at least one activated service does not satisfy the termination condition at block 406. Specifically, at block 408, method 400 may maintain operation of the at least one activated service. In an aspect, for example, UE 100 (FIG. 1) may execute service manager 120 (FIG. 1) to maintain operation of the at least one activated service (e.g., WWAN service, Bluetooth service, GPS service, WLAN service).

Otherwise, method 400 may proceed to block 410 based on determining that the at least one activated services satisfies the termination condition at block 406. In particular, at block 410, method 400 may determine whether the at least one activated service was activated in response to an indication received from an interface unit of the UE. In an aspect, for example, UE 100 (FIG. 1) may execute service manager 120 (FIG. 1) to determine whether the at least one activated service (e.g., WWAN service, Bluetooth service, GPS service, WLAN service) was activated in response to an indication received from an interface unit (e.g., user interface 130, FIG. 1) of the UE (e.g., UE 100, FIG. 1).

Method 400 may proceed to block 412 based on determining that the at least one activated service satisfies the termination condition at block 406 and the at least one service was activated by the interface unit of the UE at block 410. Specifically, at block 412, method 400 may maintain operation of the at least one activated service. In an aspect, for example, UE 100 (FIG. 1) may execute service manager 120 (FIG. 1) to maintain operation of the at least one activated service (e.g., WWAN service, Bluetooth service, GPS service, WLAN service).

Otherwise, method 400 may proceed to block 414 based on determining that the at least one activated service satisfies the termination condition at block 406 and the at least one service was not activated by the interface unit between the application and the at least one service at block 410. In particular, at block 414, method 400 may terminate operation of the at least one activated service (e.g., WWAN service, Bluetooth service, GPS service, WLAN service) associated with the hardware component (e.g., WWAN component 104, Bluetooth component 106, GPS component 108, WLAN component 110, FIG. 1) of the UE (e.g., UE 100, FIG. 1).

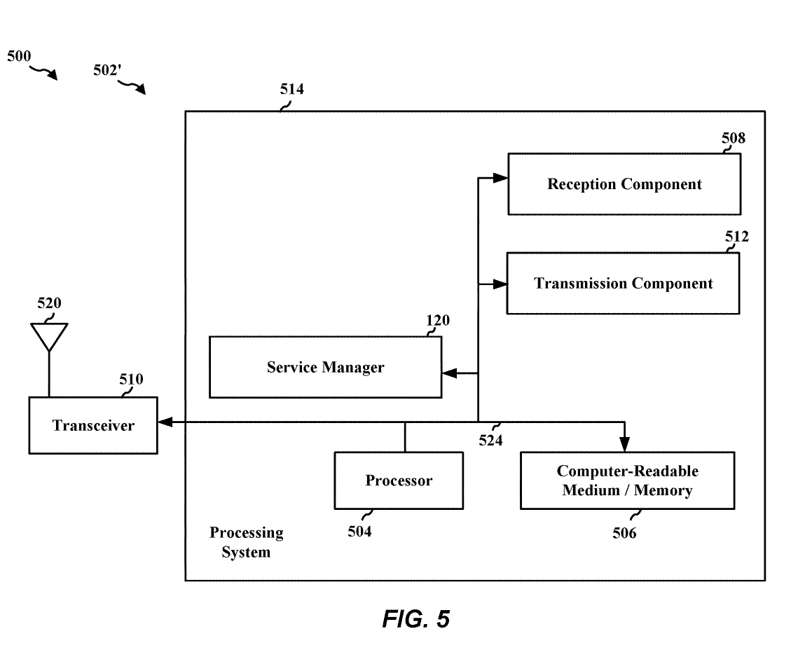

FIG. 5 is a diagram 500 illustrating an example of a hardware implementation for an apparatus 502′ employing a processing system 514 that includes service manager (FIG. 1). The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the components 504, 508, 512, and 120, and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 504. In addition, the transceiver 510 receives information from the processing system 514, specifically the transmission component 512, and based on the received information, generates a signal to be applied to the one or more antennas 520. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The components may be software components running in the processor 504, resident/stored in the computer readable medium/memory 506, one or more hardware components coupled to the processor 504, or some combination thereof.

In one configuration, the apparatus 502/502′ includes means for detecting that a service deactivation triggering condition has been met. The apparatus 502/502′ further includes means for determining whether at least one activated service satisfies a termination condition in response to detecting that the service deactivation triggering condition has been met. The apparatus 502/502′ further includes means for maintaining operation of the at least one activated service based on determining that the at least one activated service does not satisfy the termination condition. The apparatus 502/502′ further includes means for determining whether the at least one activated service was activated based on an indication received from an interface unit of the UE based on determining that the at least one activated service satisfies the termination condition. The apparatus 502/502′ further includes means for terminating operation of the at least one activated service based on determining that the at least one activated service satisfies the termination condition and the at least one activated service was not activated by the interface unit between the application and the at least one activated service. The aforementioned means may be one or more of the aforementioned components of the apparatus 502 and/or the processing system 514 of the apparatus 502′ configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of service management at a user equipment (UE), comprising:
detecting that a service deactivation triggering condition has been met;
determining whether at least one activated service satisfies a termination condition in response to detecting that the service deactivation triggering condition has been met;
maintaining operation of the at least one activated service based on determining that the at least one activated service does not satisfy the termination condition;
determining whether the at least one activated service was activated in response to an indication received from an interface unit of the UE based on determining that the at least one activated service satisfies the termination condition;
terminating operation of the at least one activated service based on determining that the at least one activated service satisfies the termination condition and the at least one activated service was not activated by the interface unit of the UE; and
maintaining operation of the at least one activated service based on determining that the at least one activated service satisfies the termination condition and the at least one activated service was activated by the interface unit of the UE.

2. The method of claim 1, wherein detecting that the service deactivation triggering condition has been met includes determining that a defined time period has been satisfied.

3. The method of claim 1, wherein detecting that the service deactivation triggering condition has been met includes detecting a termination of the application.

4. The method of claim 1, wherein determining whether the at least one activated service satisfies the termination condition includes determining whether the at least one activated service remains active while an active application list does not include at least one application.

5. The method of claim 1, wherein terminating operation of the at least one activated service includes purging one or more applications from an active application client list.

6. The method of claim 1, further comprising:
receiving a request from an application to activate at least one service associated with a hardware component of the UE;
determining whether the at least one service associated with the hardware component of the UE is active;
adding the application requesting the at least one service to an active application list associated with the at least one service based on determining that the at least one service is active;
activating the at least one service based on determining that the at least one service is inactive; and
adding the application requesting the at least one service to the active application list associated with the at least one activated service in response to activating the at least one service.

7. The method of claim 6, wherein the request is received by a service management entity residing between the application and a controller of the at least one service.

8. The method of claim 1, wherein the at least one activated service includes a global positioning system (GPS) service, a wireless local area network (WLAN) service, a Bluetooth service, or a wireless wide area network (WWAN) service.

9. The method of claim 1, wherein the at least one activated service is associated with a hardware component and corresponds to a GPS service associated with a GPS component.

10. The method of claim 1, wherein the at least one activated service is associated with a hardware component and corresponds to a WLAN service associated with a WLAN component.

11. The method of claim 1, wherein the at least one activated service is associated with a hardware component and corresponds to a Bluetooth service associated with a Bluetooth component.

12. The method of claim 1, wherein the at least one activated service is associated with a hardware component and corresponds to a WWAN service associated with a WWLAN component.

13. An apparatus for service management, comprising:
means for detecting that a service deactivation triggering condition has been met;
means for determining whether at least one activated service satisfies a termination condition in response to detecting that the service deactivation triggering condition has been met;
means for maintaining operation of the at least one activated service based on determining that the at least one activated service does not satisfy the termination condition;
means for determining whether the at least one activated service was activated in response to an indication received from an interface unit of a user equipment (UE) based on determining that the at least one activated services satisfies the termination condition;
means for terminating operation of the at least one activated service based on determining that the at least one activated service satisfies the termination condition and the at least one activated service was not activated by the interface unit between the application and the at least one activated service; and
means for maintaining operation of the at least one activated service based on determining that the at least one activated service satisfies the termination condition and the at least one activated service was activated by the interface unit of the UE.

14. The apparatus of claim 13, wherein the means for detecting that the service deactivation triggering condition has been met includes at least one of:
means for determining that a defined time period has been satisfied, or
means for detecting a termination of the application.

15. The apparatus of claim 13, wherein the means for determining whether the at least one activated service satisfies the termination condition includes means for determining whether the at least one activated service remains active while an active application list does not include at least one application.

16. A computer-readable medium storing computer executable code, comprising code to:
detect that a service deactivation triggering condition has been met;
determine whether at least one activated service satisfies a termination condition in response to detecting that the service deactivation triggering condition has been met;
maintain operation of the at least one activated service based on determining that the at least one activated service does not satisfy the termination condition;
determine whether the at least one activated service was activated in response to an indication received from an interface unit of a user equipment (UE) based on determining that the at least one activated services satisfies the termination condition;
terminate operation of the at least one activated service based on determining that the at least one activated service satisfies the termination condition and the at least one activated service was not activated by the interface unit between the application and the at least one activated service; and
maintain operation of the at least one activated service based on determining that the at least one activated service satisfies the termination condition and the at least one activated service was activated by the interface unit of the UE.

17. The computer-readable medium of claim 16, wherein to detect that the service deactivation triggering condition has been met, the computer executable code further includes code to:
determine that a defined time period has been satisfied, or
detect a termination of the application.

18. The computer-readable medium of claim 16, wherein to determine whether the at least one activated service satisfies the termination condition, the computer executable code further includes code to determine whether the at least one activated service remains active while an active application list does not include at least one application.

19. An apparatus for service management, comprising:
a memory; and
at least one processor coupled to the memory and configured to:
detect that a service deactivation triggering condition has been met;
determine whether at least one activated service satisfies a termination condition in response to detecting that the service deactivation triggering condition has been met;
maintain operation of the at least one activated service based on determining that the at least one activated service does not satisfy the termination condition;
determine whether the at least one activated service was activated in response to an indication received from an interface unit of a user equipment (UE) based on determining that the at least one activated services satisfies the termination condition;
terminate operation of the at least one activated service based on determining that the at least one activated service satisfies the termination condition and the at least one activated service was not activated by the interface unit between the application and the at least one activated service; and
maintain operation of the at least one activated service based on determining that the at least one activated service satisfies the termination condition and the at least one activated service was activated by the interface unit of the UE.

20. The apparatus of claim 19, wherein to detect that the service deactivation triggering condition has been met, the at least one processor is further configured to determine that a defined time period has been satisfied.

21. The apparatus of claim 19, wherein to detect that the service deactivation triggering condition has been met, the at least one processor is further configured to detect a termination of the application.

22. The apparatus of claim 19, wherein to determine whether the at least one activated service satisfies the termination condition, the at least one processor is further configured to determine whether the at least one activated service remains active while an active application list does not include at least one application.

23. The apparatus of claim 19, wherein to terminate operation of the at least one activated service, the at least one processor is further configured to purge one or more applications from an active application client list.

24. The apparatus of claim 19, wherein the at least one processor is further configured to:
receive a request from an application to activate at least one service associated with a hardware component of the UE;
determine whether the at least one service associated with the hardware component of the UE is active;
add the application requesting the at least one service to an active application list associated with the at least one service based on determining that the at least one service is active;
activate the at least one service based on determining that the at least one service is inactive; and
add the application requesting the at least one service to the active application list associated with the at least one activated service in response to activating the at least one service.

25. The apparatus of claim 24, wherein the request is received by a service management entity residing between the application and a controller of the at least one service.

26. The apparatus of claim 19, wherein the at least one activated service includes a global positioning system (GPS) service, a wireless local area network (WLAN) service, a Bluetooth service, or a wireless wide area network (WWAN) service.

27. The apparatus of claim 19, wherein the at least one activated service is associated with a hardware component and corresponds to a GPS service associated with a GPS component.

28. The apparatus of claim 19, wherein the at least one activated service is associated with a hardware component and corresponds to a WLAN service associated with a WLAN component.

29. The apparatus of claim 19, wherein the at least one activated service is associated with a hardware component and corresponds to a Bluetooth service associated with a Bluetooth component.

30. The apparatus of claim 19, wherein the at least one activated service is associated with a hardware component and corresponds to a WWAN service associated with a WWLAN component.
